(19) United States
(12) Patent Application Publication
(10) Pub. No.: US 2005/0223616 A1
(43) Pub. Date: Oct. 13, 2005

(54) Handheld holding and measuring device for fish and method of use

(76) Inventor: Martin Linde Beasley, Prairieville, LA (US)

Correspondence Address: MARTIN L. BEASLEY, 17360 JOHN BROUSSARD ROAD, PRAIRIEVILLE, LA, 70769, US

(21) Appl. No.: 10/794,078

(22) Filed: Mar. 8, 2004

(51) Int. Cl. A01K 1/00

(52) U.S. Cl. 43/4

(57) ABSTRACT

An improved handheld device for holding and measuring fish generally comprised of two troughs of rigid material with end walls and known length attached longitudinally with a hinge. The distance between the end walls is made equal to the minimum legal length established for the species of fish for which the device is to be used. The device is grasped by the fisherman and held on the hand by straps on the convex surfaces of the troughs. The troughs are then closed around the fish. The known length between the end walls of the troughs provides a means of determining if a fish meets minimum size requirements. Textured surfaces attached to end walls act as jaws to hold the fish securely for hook removal. The device provides protection from cuts and abrasions to the fisherman as well as eliminating the need to precisely measure the fish. The device is lined with protective material to reduce stress on the fish and restrict its movement. The device eliminates the need to place the fish in contact with the fisherman or surfaces within the vessel thereby reducing the deposition of fish slime on the fisherman or vessel.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to measuring fish, specifically to devices to hold and measure fish to determine if minimum length requirements are met.

There has long been a need for a fish holding device that protects both the fish and the fisherman and provides a means of holding and measuring the fish. States and other governmental units have imposed size limits on fish, establishing the minimum length of fish of particular species that may legally be possessed. As a result of these size limits, many species of fish must be measured to determine if the fish meets the minimum size requirements. The measuring process may involve risk of serious injury both to the fish and the fisherman.

Many approaches to measuring fish can be found in the prior art, but each of the known approaches exhibits disadvantages that are addressed by the present invention. The most common approach to measuring a fish is to place the fish against a general measuring device such as a yardstick or measuring tape. In this approach, the fisherman must position the struggling fish properly relative to the measuring device and read the length from markings on the measuring device. This approach has the disadvantages of exposing the fisherman to serious injury caused by sharp or pointed parts of the fish; exposing the fish to injury due to excess handling causing puncture wounds, loss of scales, and loss of slime; and presenting difficulty obtaining accurate measurements in low-light conditions.

In a related approach, the measuring device is fixed to a boat or other structure and the fisherman is required to place the fish against the boat or structure. This approach has the same disadvantages as the previously mentioned approach with the added disadvantage of the deposition of fish slime on the boat or structure to which the measuring device is fixed.

The prior art includes inventions of the pliers type to hold fish after they have been landed. Possibly the best known of the prior art is embodied in U.S. Pat. No. 5,568,698 issued Oct. 29, 1996 to Raymond W. Harding and Kelly M. Harding; U.S. Pat. No. 4,563,833 issued Mar. 15, 1985, to Raymond U. Aucoin; and U.S. Pat. No. 5,092,074 issued Mar. 3, 1992 to Milo E. Zincke. These devices, while representative of the prior art, are of a pliers type design which fails to embody features that have been recognized as being desirable for the following reasons: (1) The fish is held in the jaws of pliers frequently under high load which may cause serious damage to the fish. This is undesirable especially if the fish is to be released, (2) These devices provide no protection to the fish, and (3) These devices provide no means for direct measurement. As a result, additional handling by the fisherman is required to align the fish with a measuring device. Additional handling of a struggling fish puts the fisherman at risk to injury.

The prior art also includes inventions to measure fish. Possibly the best known prior art in the field of fish measurement is embodied in U.S. Pat. No. 5,339,532 issued Aug. 23, 1994 to John G. O'Keefe, U.S. Pat. No. 5,097,617 issued Mar. 24, 1992 to Gene C. Craven, and U.S. Pat. No. 5,148,607 issued Sep. 22, 1992, to Rupert W. Lasiter. While representative of the prior art, these devices require the fish to be inserted into an enclosure or tray. The fisherman is then required to remove the fish from the enclosure or tray thereby increasing handling of the fish by the fisherman. These designs fail to embody features that have been recognized as being desirable for the following reasons: (1) The fisherman must grasp or contact the fish to perform the measurement, (2) These device provides no means to hold the fish for extraction of the hook, and (3) These devices provide no protection to the fish. The present invention provides for holding and measuring and allows the fisherman to hold the fish securely for hook removal without coming into direct contact with the fish. Each of the above approaches requires extensive handling of the fish, increasing the risks of injury to the fish and fisherman. Many efforts are made to release fish unharmed to decrease mortality of released fish that do not meet the size requirements. The present invention provides a protective device to hold a fish and to determine if the fish meets minimum length requirements without the need for the user to come into direct contact with the fish.

It is evident that there is a continuing need for a holding and measuring device for fish, specifically, there is a need for holding fish securely while avoiding damage to the fish and the fisherman. In addition, there is a need for a device that allows measurement of the fish without handling by the fisherman. The present invention addresses these needs by providing a device that holds a fish in a manner that provides safety to the fisherman and the fish, and allows the fisherman to determine if the fish exceeds a certain minimum required length for possession.

### BRIEF SUMMARY OF THE INVENTION

The present invention is a device for holding and measuring fish. The device includes a first and second sheet of rigid material in the shape of a shallow trough of fixed length. The trough-shaped sheets are connected pivotally by a hinge along the longitudinal axis allowing the device to be opened to accept a fish then closed to form a hollow elliptical cylinder that encases the fish. A strap or handle is mounted on the convex side of each sheet to hold the device on the hand of the user. The trough-shaped sheets contain first and second end walls with textured surfaces to hold a fish securely for hook removal after measurement. The concave portion of the trough-shaped sheets is lined with resilient padding material forming a padded enclosure that protects the fish and restricts the fish's movement within the device. The fixed length between the end walls of the trough-shaped sheets corresponds to the minimum size required to possess the fish. The hooked fish is brought to the device which is held open by holding open the hand on which the device rests. The device is then closed around the fish by closing the hand on which the device rests, thereby pushing the first and second trough-shaped sheets together. The fisherman can then grasp the fishing line and pull the fish to the first end wall of the trough-shaped sheets. The fish is determined to be under the minimum required size if the tail does not extend past the second end wall of the trough-shaped sheets and over the minimum required size if the tail extends past the second end wall of the trough-shaped sheets. The fisherman can then open the device enough to move the fish between the textured surfaces that are perpendicularly fixed to the end walls, then close the device enough to hold the fish for extraction of the hook. The fisherman may then either keep or release the fish unharmed. The device allows measurement for minimum size requirements without depositing fish slime on the fisherman or on the vessel which is typical of other methods of measuring. The device also protects the fisherman from wounds inflicted by handling the fish as well as preventing transfer of bacteria from the fish or waters to the fisherman. The resilient padding on the concave sides of the trough-shaped sheets also protects the fish by reducing the amount of slime lost, reducing the amount of scales lost, and eliminating wounds caused by other fish holding devices. Other embodiments include indicia on the device to measure any item and a slot with adjacent indicia to accurately measure fish shorter than the device. Accordingly, several objects and advantages of the present invention include:
(a) to provide a secure method and device to hold a fish without the need for the fisherman to contact the fish.
(b) to provide a device with a protective lining that reduces damage to the fish.
(c) to provide a device that allows a fisherman to handle a fish without contacting the fish thereby offering the fisherman protection from wounds inflicted by the fish.
(d) to provide a device that allows the fisherman to quickly and accurately determine if the fish exceeds the minimum required length for possession without additional handling or directly contacting the fish.
(e) to provide a device that allows the fisherman to hold the fish securely so the hook can be extracted from the fish's mouth.
(f) to provide a device with indicia that allows measurement of lengths other than the fixed length of the device.
(g) to provide a device with a surface that is receptive to printing and labeling.

### BRIEF DESCRIPTION OF THE DRAWINGS

FIG. 1 is a perspective view of the preferred embodiment in the closed position.

FIG. 2 is an end view of the preferred embodiment in the closed position.

FIG. 3 is a perspective view of the preferred embodiment in the partially open position in the hand of a user.

FIG. 4 is an end view of the preferred embodiment in the partially open position in the hand of a user.

FIG. 5 is a perspective view of the preferred embodiment in the fully open position.

FIG. 6 is an end view of the preferred embodiment in the fully open position.

FIG. 7 is a perspective view of another embodiment in the closed position showing position of fish within device.

FIG. 8 is a perspective view of the preferred embodiment in the fully open position showing position of fish within device.

FIG. 9 is a plan view of the preferred embodiment further showing indicia and slot.

FIG. 10 is a sectional taken along line 5-5 of FIG. 9.

FIG. 11 is a plan view showing legal fish of greater length than distance between end walls.

FIG. 12 is a plan view showing illegal fish of lesser length than distance between end walls.

### DETAILED DESCRIPTION OF THE INVENTION

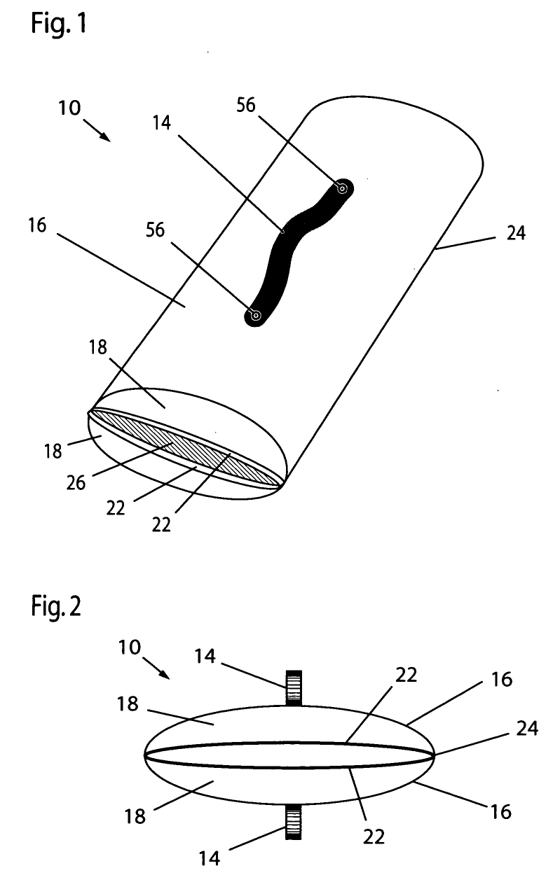

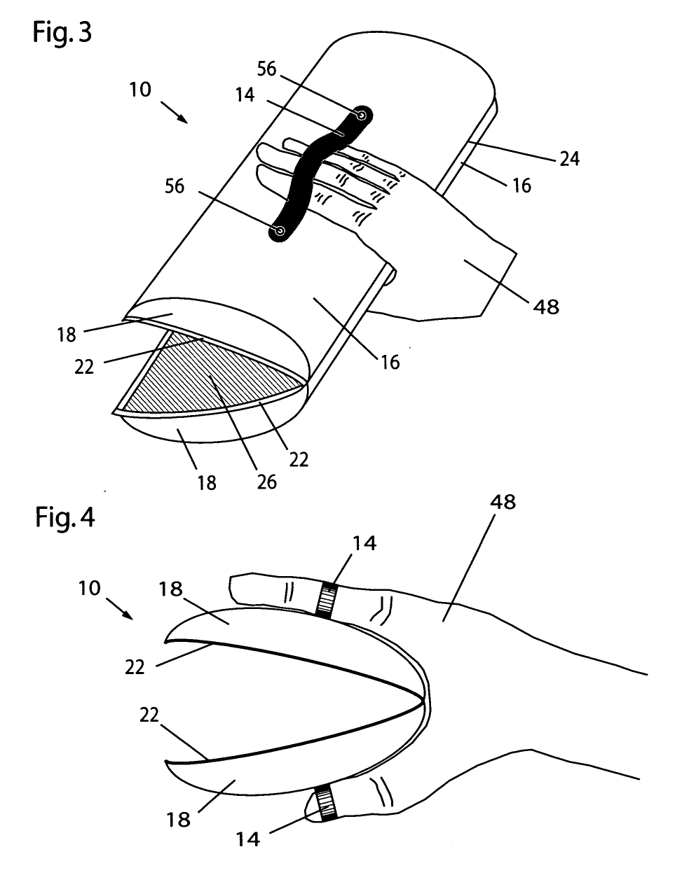

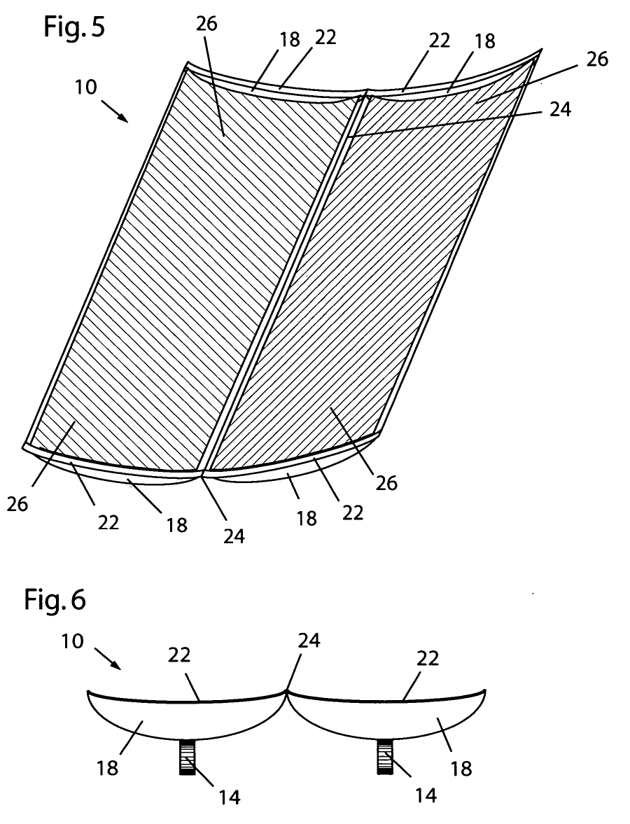

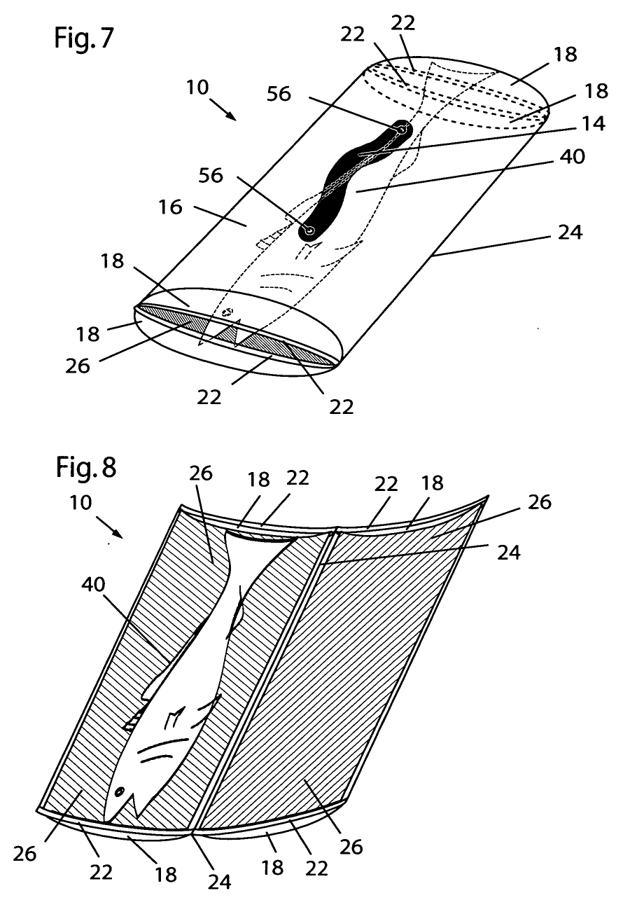

A fish holding and measuring device 10 in accordance with the present invention is illustrated generally in FIGS. 1-8. A typical embodiment of the fish holding and measuring device of the present invention in the closed position is illustrated in FIG. 1. The fish holding and measuring device has a first and second sheet of rigid material 16, each in the shape of a trough. In the preferred embodiment the trough-shaped sheets are made of plastic such as Polyethylene or Polypropylene. Hinge 24 connects the said plastic sheets along their longitudinal axis thereby allowing relative closing and opening movement of the plastic sheets 16 when the first and second sheets 16 are moved toward each other or away from each other respectively. In the preferred embodiment, Hinge 24 is a living hinge of the same plastic material as said plastic sheets 16. When said plastic sheets 16 are moved toward each other fully, the device 10 forms the shape of a hollow elliptical cylinder. First and second end walls 18 are fixed perpendicularly to the concave side of each of said plastic sheets 16 at a fixed distance apart that is equal to the minimum length required for legal possession of the fish. A textured strip 22 is fixed perpendicularly to each end wall 18 to provide a surface for holding fish. A strap 14 is interconnected to the outside, or convex side, of the plastic sheets 16 by fasteners 56. Resilient padding 26 is fixed to the inside, or concave side, of plastic sheets 16. An end view of the device 10 in the closed position showing position of plastic sheets 16, end walls 18, textured strips 22, hinge 24 and straps 14 is illustrated in FIG. 2. A perspective view of the device 10 in the partially open position is illustrated in FIG. 3 showing a user's hand 48 grasping the device 10. An end view of the device 10 showing a user's hand 48 grasping the device 10 is illustrated in FIG. 4. A perspective view of the device 10 showing resilient padding 26 fixed to the concave side of plastic sheets 16 is illustrated in FIG. 5. An end view of the device 10 in the fully open position is illustrated in FIG. 6. A perspective view of the device 10 in the fully closed position is illustrated in FIG. 7 showing relative position of fish 40 enclosed between resilient padding 26 and plastic sheets 16. When plastic sheets 16 are moved away from each other to the fully open or partially open position as shown in FIG. 2, a fish 40 can be enclosed between resilient padding 26. A perspective view of the device 10 in the fully open position showing the relative position of fish 40 is illustrated in FIG. 8.

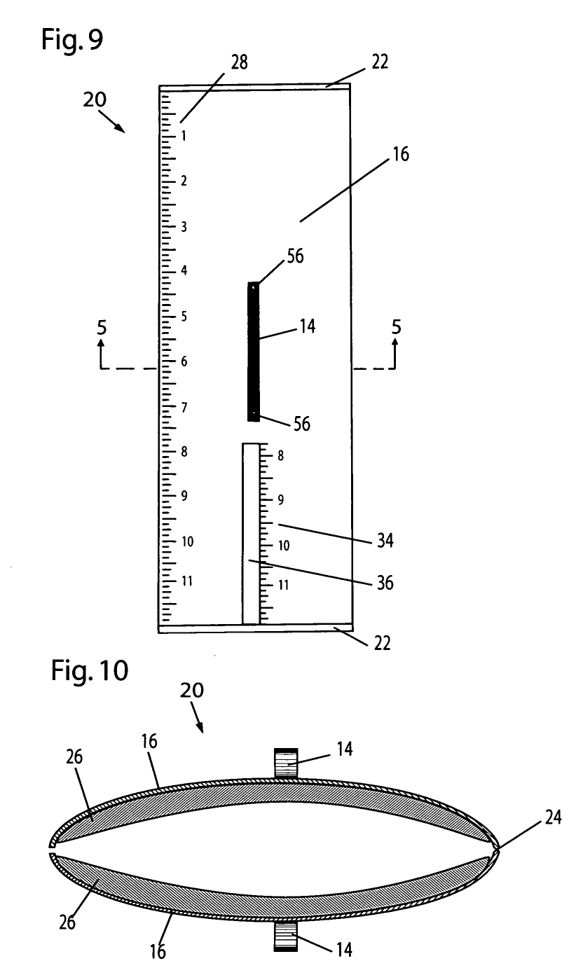

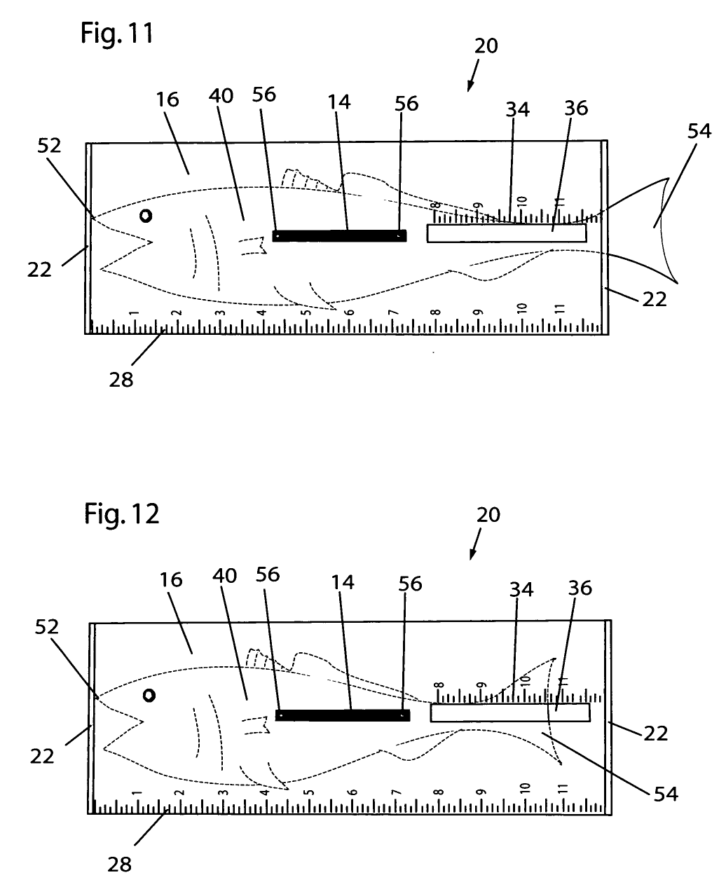

Reference is now made to FIGS. 9-12 in which is shown a second embodiment of the fish holding and measuring device designated by numeral 20. A plan view of a second embodiment of the device is illustrated in FIG. 9. This embodiment of the present invention is comprised of the previous embodiment further including indicia 28 imprinted on the convex surface of plastic sheets 16. A slot 36 in plastic sheets 16 allows a portion of fish 40 to be viewed when the device 20 is closed. Indicia 34 is imprinted adjacent to slot 36 on the convex side of plastic sheets 16 to allow precise measurement of undersized fish. A cross section taken along line 5-5 of device 20 showing resilient padding 26, plastic sheets 16, hinge 24 and straps 14 is illustrated in FIG. 10. A representation of a fish 40 that is longer than the distance between end walls 18 and is therefore legal is illustrated in FIG. 11. When the fish 40 is disposed such that its snout 52 contacts first end wall 18 and its tail 54 extends past second end wall 18, its length relative to the distance between end walls is easily determined. A representation of a fish 40 that is shorter than the distance between end walls 18 and is therefore illegal is illustrated in FIG. 12.

To hold and measure fish using the device 10 the user need only grasp the device using one hand 48 by inserting the fingers under one of the straps 14 and the thumb under the other strap 14. When the user opens his hand 48, he opens the device 10 by moving the plastic sheets 16 away from each other. When the user closes his hand 48, he closes the device 10 by bringing the plastic sheets 16 together. When closed around a fish 40, the trough-shaped plastic sheets 16 encase the fish 40 between the resilient padding 26 thereby holding the fish 40 securely. The plastic sheets 16 are of a fixed length with end walls 18 a fixed distance apart corresponding to the minimum size limit of fish 40. When fish 40 is moved such that the snout 52 is touching first end walls 18 the user needs only to ensure that the fish's tail 54 extends past the second end walls 18 to determine that the fish exceeds the fixed length between end walls 18 and therefore exceeds the minimum size required to legally retain the fish 40. After fish 40 is measured, the device 10 can be opened slightly to allow the user to move fish 40 between textured strips 22. With fish 40 between textured strips 22, the user need only close the device 10 to hold fish 40 securely for removal of fish hook. The slot 36 and adjacent indicia 34 can be used to precisely measure fish 40 shorter than the distance between end walls 18. Indicia 28 can be used to measure any item shorter than the distance between end walls 18.

1. An improved handheld device for measuring and holding fish or other objects comprised of two trough-shaped sheets of rigid material of fixed length having concave and convex sides, first and second ends, first and second end walls spaced a fixed distance apart having convex and concave edges and interconnected perpendicularly along said convex edges to said first and second ends of said trough-shaped sheets and extending perpendicularly from said concave sides of said trough-shaped sheets, and first and second longitudinal edges, said first longitudinal edge of one said trough-shaped sheet pivotally interconnected to said second edge of the other said trough-shaped sheet.

2. The device of claim 1, wherein textured strips are further included and are interconnected perpendicularly to said concave edges of said end walls.

3. The device of claim 1 or 2, wherein a resilient pad is further included and is interconnected to the concave side of one or both of said trough-shaped sheets.

4. The device of claims 1, 2, or 3 wherein a strap is further included and is interconnected to the convex side of said trough-shaped sheets.

5. The device of claims 1, 2, 3, or 4, wherein one or both of said trough-shaped sheets includes a slot, and wherein said slot is disposed at the second end and in the center of said trough-shaped sheet parallel to said longitudinal edge of said trough-shaped sheet.

6. The device of claim 5, wherein indicia are further included and are disposed adjacent to and along the longitudinal axis of said slot.

7. The device of claims 1, 2, 3, 4, 5, or 6, wherein said trough-shaped sheets are molded from polymeric material.

8. The device of claims 1, 2, 3, 4, 5, 6, or 7, wherein indicia are further included on the convex side of said trough-shaped sheets and wherein said indicia are disposed along the longitudinal edge of said trough-shaped sheets that is not interconnected to second said trough-shaped sheet.

9. An improved handheld fish holding and measuring device comprised of two substantially curved sheets of rigid material having convex and concave sides, first and second ends, and first and second longitudinal edges, said sheets being straight along their longitudinal axis and curved perpendicular to said longitudinal axis, wherein said first longitudinal edge of one of said curved sheets is pivotally interconnected to said second longitudinal edge of the other said curved sheet, and having first and second end walls spaced a fixed distance apart having convex and concave edges and interconnected perpendicularly along said convex edges to said first and second ends of said curved sheets and extending perpendicularly from said concave sides of said curved sheets.

10. The device of claim 9, wherein textured strips are further included and are interconnected perpendicularly to said concave edges of said end walls.

11. The device of claim 9 or 10, wherein resilient padding is interconnected to the concave side of one or both of said curved sheets.

12. The device of claims 9, 10 or 11, wherein a strap is interconnected to the convex side of said curved sheets.

13. The device of claims 9, 10, 11, or 12, wherein one or both of said curved sheets includes a slot, and wherein said slot is disposed at the second end and in the center of said curved sheet parallel to said longitudinal edge of said curved sheet.

14. The device of claim 13, wherein indicia are further included and are disposed adjacent to and along the longitudinal axis of said slot.

15. The device of claims 9, 10, 11, 12, 13, or 14, wherein said curved sheets are molded from polymeric material.

16. The device of claims 9, 10, 11, 12, 13, 14, or 15, wherein indicia are further included on the convex side of one or both of said curved sheets and wherein said indicia are disposed along the longitudinal edge of said curved sheets that is not interconnected to second said curved sheet.

17. A method of holding and measuring the length of a fish relative to a preselected length, using a fish holding and measuring device having two trough-shaped sheets of rigid material having concave and convex sides, first and second ends, and first and second longitudinal edges, said first longitudinal edge of one sheet pivotally interconnected to said second longitudinal edge of the other sheet, and having end walls, the distance between said end walls being equal to the preselected length, and having straps interconnected to the convex side of said trough-shaped sheets, comprising the steps of
holding the device in the first hand of the user and opening the device by opening said first hand on which the device rests;
holding the fishing line that is interconnected to the hook that is lodged in the fish's mouth with the second hand of the user such that the fish is in a generally vertical position with snout upward and tail downward;
bringing said fishing line toward the device such that the fish is positioned between said trough-shaped sheets;
closing the said first hand on which the device rests thereby sandwiching the fish between said trough-shaped sheets;
pulling said fishing line with said second hand such that the snout of the fish is against said first end wall of said trough-shaped sheets;
determining whether the tail of the fish extends past, or ends short of, said second end walls of said trough-shaped sheets thereby determining whether the fish is respectively longer than or shorter than the preselected length;
opening said first hand, and thereby moving said trough-shaped sheets away from each other, and positioning the fish between said first end walls;
closing said first hand, and thereby moving said trough-shaped sheets toward each other, such that the fish is held between said first end walls;
dislodging said hook from fish's mouth;
opening said first hand, and thereby moving said trough-shaped sheets away from each other, and releasing fish from the device.
